(19) United States
(12) Patent Application Publication
(10) Pub. No.: US 2004/0154023 A1
(43) Pub. Date: Aug. 5, 2004

(54) Processing method of self-description data object

(76) Inventors: Rong Chen, Shanghai (CN); Yuzhou Liang, Shanghai (CN); Zhongqiang Ye, Shanghai (CN); Weihan Wang, Shanghai (CN)

Correspondence Address: RABIN & BERDO, P.C., Suite 500, 1101 14th Street, N.W., Washington, DC, 20005, US

(21) Appl. No.: 10/747,231

(22) Filed: Dec. 30, 2003

(30) Foreign Application Priority Data
Dec. 31, 2002 (CN) 02159494.5

(51) Int. Cl. G06F 3/00

(52) U.S. Cl. 719/310

(57) ABSTRACT

A processing method of self-description data object, in data object utilization, allocate the store space to data object sample and assign the data object sample, in canceling the utilization of the data object sample, release the store space occupied by the data object. The user needn't know about the internal structure of the data class in present invention, and could access the relative internal structure element with only the method provided by this data class. In compatibility with COM technology, the present invention provides a store structure of data class. The present invention has the following advantages: the ideal data information could be obtained through limited parameter transfer; the service component load may be reduced effectively and response promptly to the application request; the data double meaning may be reduced, computing error is avoided and meet the compatibility requirement of component.

### FIELD OF THE INVENTION

The present invention relates to a processing method of self-description data object, especially relates to a data processing method, in which, the user needn't know about the internal structure of the data class in present invention, and could access the relative internal structure element with only the method provided by this data class, the present invention belongs to the computer technology field.

### BACKGROUND OF THE INVENTION

The basic purpose of utilizing computer is that the computer could handle more data and information in various fields rapidly. The main work of software programmer is design the language according to the relative process method and steps by program, e.g. C/C++ language to make the computer serving the human in limited conditions.

Every programming language defines some data class to contain information data, and most data class, especially some simple data class have a simple co-relation in other programming language, e.g. character class data (char), complete class data (int) and long complete class data (long) etc. For easy organizing data by software developer, most programming languages (e.g. C/C++ language) supports also the user self-defined data class derived from some key words on basis of the existing data class, e.g: class data class (class), structure data class(struct) and combined data class(union) etc.

In the desktop operation system from U.S. Microsoft Co (e.g. WINDOWS 98), its character string data class mainly are pointer class of character pointer (char*) or word pointer (wchar-t*); although character pointer (char*) or word pointer (wchar-t*) are belonged to the self-description data class in certain extent, but to component technology, the information has some drawbacks; e.g. no character string length describing information.

In the development and application of middleware, the marshalling and un-marshalling of component interface parameter plays a key role, apart from the simple process of complete- and Bull-class, other completive class would waste large resource for the marshalling and un-marshalling of parameter process. Although the system could obtain the information through standard library (lib) function in parameter marshalling and un-marshalling transferring, but to service terminal, the system load is increased, because the length of character string is set in in the initial setup, and the character string class is one of the most utilizing data class, to the operation system, this is a waste.

In traditional programming (e.g. C/C++ language), after setting a 1000 bytes buffer storage space, it would simple defined as:

#define BUFLENGTH 1000
BYTE buf[BUFLENGTH];

The developer cares about the real content participating in computing in data buffer storage space (buf) rather than the self-description of buffer storage space (buf).

In network computing, the data without characteristic may lead to unnecessary load to service. For example above, the information of buffer storage space (buf) too little, in time of passing this section of data to certain remote service interface to avoid overflow, it must affix the buffer storage space (buf) volume; e.g. (C/C++ language):

HERSULT—stdcall X-method (
BYTE*pBuf,
INT capacity);

If some content in the buffer storage space (buf) is being utilized by other service and want it to be un-overwritten in present service, then the interface method realization would declare as following:

HERSULT—stdcall X-method (
BYTE*pBuf,
INT capacity),
INT used);

The parameter used indicates the used byte.

However this definition of interface method has no succeeded for that it make service terminal to waste extra process for identifying the last two parameters. The basic reason for this interface method definition is: traditional operation system didn't define a suitable data class to handle it for this parameter transferring. In the application program of network oriented, the data should be self-description.

The self-description data class is like: the data information in the data class itself could describe enough its characteristic, e.g. store occupation, basic attribution and other relative information etc, it could realize self-description data class under condition of no other appendix condition.

In the data class of traditional programming language, the data class of double and float etc which are compatible with ISTORE real number standard are a kind of self-description data class. Suppose the service terminal obtains a double parameter, the service terminal could define:

\hat{1} Obtain a continuous store area which occupies 8 bytes;

\hat{2} 64 bits all together;

\hat{3} the first bit is symbol bit, 11 bit is a index bit, 52 bit is a end bit;

\hat{4} The value range is ±1′7e³⁰⁸.

The information describes the characteristic of data class enough. If a character string pointer (char*)class parameter is transferred, it may be known that it is a 32 bits pointer pointing to character buffer storage space with byte as unit, the continuous space is ended with ‘\0’. If the start & end address of the continuous character space could be obtained, the character string length may be obtained, so the character string pointer (char*) data class is a self-description one. But the byte pointer (byte*) or (void*/PVOID) data class is not the self-description one because the information in itself is not enough to describe itself.

The non-pointer basic data class is a self-description one basically, and other basic data class pointer class is not self-description one basically other than character pointer.

Moreover, in C/C++ language, it supports the user self-defining data class apart from the basic data class, e.g.:

classdef class CStudent CStudent, *p Student;
class Cstudent{
BYTE *pData;
Public:
INT age;
Char *pClassName;
};

For this example, Cstudent and pStudent are not the self-description data class, the element pData has no character of self-description. By little modifying it is like:

classdef class Cstudent Cstudent, *pStudent;

class Cstudent{
INT dataLen;
BYTE *pData;
Public:
INT age;
Char *pClassName;
};

In which, the new added element variable dataLen is for recording the data pointer pData. To some extent application, it meets the requirement of self-description data class. However it can't be seen as the self-description data class of operation system for that this data class is by user self defining, and operation system couldn't know the concrete user deciding. So the self-description data class is relative to requirement in application. In real development, the most effective information should be included through the most designing according to requirement, it don't need to follow the self describing effect in hard because the self describing need extra system storage resource.

The PC function has been advanced since 80′ and the market requires the file co-matching, e.g. in word process software MS Word file developed by U.S. Microsoft Co, the electronic table process software MS Excel developed by the company is needed to be inserted frequently. So U.S. Microsoft Co developed the object link and embedding (object Linking Embedding, OLE for short) technology. Owing to the OLE has no enough theory base of program model, so Microsoft Co developed further the component object model (COM for short) technology in 90′. The COM technology is a programming specification in practice. The program model meets the COM specification may be linkage installed dynamically just like the co-mounting of standard screw and nut.

In COM technology, the inter-action between application program, application program and system is realized by function of a group interfaces. The COM component may be realized by more programming languages; the program of client terminal may be compiled with different programming language. The COM technology defines the interface description language (short in idl). As a language, it defines the most basic data class supported by most programming languages, and supports some specific data class for OLE automation (OLE, automation), such as data class BSTR and data class SAFEARRY etc.

The basic self-description data class couldn't embody its advantage in traditional development for that in traditional two layers hierarchy designing of single program or “client/server” (C/S), it has little requirement to data self describing; the problem could be resolved by the user self-deciding and extra parameter transfer, and the resource consumption to two layers hierarchy structure is very little.

However, in today's rapid develop network technology, the new technologies of three layers of “client/middleware/server” or even more layers hierarchy structure, middleware technology and grid network computing have been developed out and the traditional operation system couldn't suitable meet the WEB service requirement.

### BRIEF DESCRIPTION OF THE INVENTON

The main purpose of present invention is providing a processing method of self-description data object, the user needn't know about the internal structure of the data class in present invention, and could access the relative internal structure element with only the method provided by this data class.

More purpose of present invention is providing a processing method of self-description data object, provide the self-description data class of byte buffer data class and character string buffer data class etc, utilizing the self-description data class of data buffer storage to act as the transfer interface parameter and increase data process efficiency.

More purpose of present invention is providing a processing method of self-description data object, under condition of compatible with COM technology, provide the store structure of data class and realize a extension to COM technology.

The purpose of present invention is realized as below:

A processing method of self-description data object, it includes at least: in data object utilization, allocate the relative store space to data object sample and assign the data object sample, in canceling the utilization of the data object sample, release the store space occupied by the data object.

The method includes further: judge the effectiveness of data object sample class, and return back the judge result.

The method includes further: changeover with force the utilized data object sample class.

When the data object sample is a character string object,

Said concrete operation of allocating the relative store space for data object includes at least: create the character string object sample for specified character string in memory, allocate the store space of specified effective length to the character string object sample;

Said concrete operation of allocating the relative store space for data object sample includes at least: re-create the character string object sample, and release the store space of original character string object sample; re-create the character string object sample according to the effective length, and release the store space of original character string object sample.

When the data object sample is a character string or character buffer storage object, the method includes further: read out the character string length or character number.

When the data object sample is a character string object, the method includes further: compare two character string objects.

When the data object sample is byte or character buffer storage object, said concrete operation of allocating the relative store space for data object sample is: if the byte or character buffer storage object sample doesn't existed, allocate non-initialized or initialized store space of specified quantity to the byte or character buffer storage object sample; otherwise it doesn't operate for store allocation.

When the data object sample is byte buffer storage object, the method includes further: read out the utilized byte number, set the utilized byte number, insert the specified new content in buffer storage space of byte buffer storage sample object, if it exceeds the volume of buffer storage space, the exceeded content would be truncated or lost.

When the data object sample is byte or character buffer storage object, the method includes further: read out the buffer area volume, assign new value to the existed byte buffer storage object, and add in new content behind the utilized buffer storage space, when it exceeds the buffer storage space, the exceeded part would be truncated.

When the data object sample is array object, said method includes at least: declare a array description, copy the array pointer; declare a array object and allocate the store for buffer area at same time, if the array object sample doesn't existed, allocate non-initialized or initialized store space of specified quantity to the array object sample, otherwise it doesn't operate for store allocation; copy the array buffer area of array object.

When the data object sample is array object, the method includes further: obtain the array length, access the array element, and create dynamically the array object, allocate the store for buffer area at same time, and return back the array description.

When the data object sample is array object, and delete the array object, the method includes further: delete the array buffer area, and release the occupied store space.

Said character string object has at least: 1^{st} area, 2^{nd} area and 3^{rd} area; in which, the 1^{st} area stores the 2^{nd} area length; 2^{nd} area stores the uniform character coding standard character string; 3^{rd} area stores end mark. The character string object variable may be allocated to stack or pile.

Said byte buffer object has at least: 1^{st} part, 2^{nd} part and 3^{rd} part; in which, the 1^{st} part is for the 2^{nd} part length value; 2^{nd} part stores the byte data, 3^{rd} part stores end mark. The byte buffer object variable may be allocated to stack or pile.

The character buffer storage object has at least: 1 ^{st} part, 2^{nd} part and 3^{rd} part; in which, the 1^{st} part is for the 2^{nd} part length value; 2^{nd} part stores the byte data, 3^{rd} part stores end mark.

Said byte data includes at least: 1^{st} area, 2^{nd} area and 3rd area; in which, the 1^{st} area stores the 2^{nd} area length value; 2^{nd} area stores the uniform character coding standard character string; 3^{rd} area stores end mark. The character buffer storage object variable may be allocated to stack or pile.

Said array object has at least 3 parts: in which, the 1^{st} part stores the public mark (GUID), 2^{nd} part stores the safe array (SAFEARRAY), 3^{rd} part stores array data. The array object may be allocated to stack or pile.

In present invention, the user needn't know about the internal structure of the data class in present invention, and could access the relative internal structure element with only the method provided by this data class. In the self-description data class of byte buffer data class and character string buffer data class, utilizing the self-description data class of data buffer storage to act as the transfer interface parameter and increasing data process efficiency. Under condition of compatible with COM technology, provide the store structure of data class and realize a extension to COM technology. Present invention is suitable for 3 layers of “client/middleware/server” or even more layers hierarchy structure, middleware technology, grid network computing and component technology based new operation system. It has the following advantages:

1. The ideal data information could be obtained through limited parameter transfer;

2. The service component load may be reduced effectively and response promptly to the application request;

3. The data double meaning may be decreased, unnecessary computing error is avoided;

4. Meet the compatibility requirement of component.

### BRIEF DESCRIPTION OF THE APPENDED DRAWINGS

FIG. 1 is an illustrative view showing the store structure of character string data class in present invention.

FIG. 2 is an illustrative view showing the store structure of byte buffer storage data class in present invention.

FIG. 3 is an illustrative view showing the part store structure of FIG. 2 in present invention.

FIG. 4 is an illustrative view showing the store structure of character buffer storage data class in present invention.

FIG. 5 is an illustrative view showing the store structure of array data class in present invention.

FIG. 6 is an illustrative view showing the realization relation prior the Ez data class in present invention.

FIG. 7 is an illustrative view showing the realization relation after the Ez data class improving in present invention.

FIG. 8 is a store layout of improved EzArray data class in present invention.

### DETAILED DESCRIPTION OF THE INVENTION

Next, a further description will be made as to the present invention with the Figures and concrete embodiment:

Embodiment 1

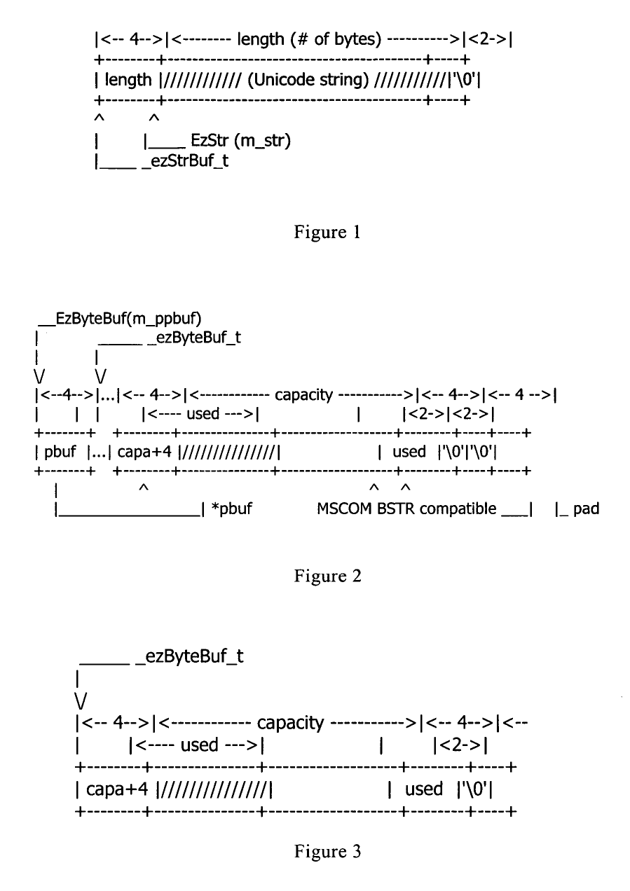

Refer to FIG. 1, the character string data class is a data structure designed for supporting component programming and usually store the user constant character string. It has a store area with constant length, and stores the user character string. It also store the character string length, the character string data class belongs to the self-description data structure; FIG. 1 is an illustrative view showing the store structure of character string data class.

The character string data class is defined as a class in C++ language, the character string data consists of 3 parts as seen from Fig.: 1^{st} part _czStrBuf_t stores the length of 2^{nd} part EzStr in character string data, 1^{st} part takes 4 bytes, 2^{nd} part stores the uniform character code standard (Unicode) character string, 3^{rd} part stores ‘/0’ character of 2 byte. This structure is same as the BSTR data class of U.S. Microsoft Component object model(short in COM).

The character string data variable may be defined to stack or pile. In the embodiment, the macro EZCSTR is defined, the character string data variable could be conveniently defined in stack through the macro. Take C++ language as example, the macro is defined as below:

```
#define EZCSTR(str)-ezcstr_fixup(sizeof(L##str)-2, (L“\0\0”L##str))
INLINE wchar_t*_ezcstr_fixup(int siz, ezStrBuft stuff)
{
    (int)stuff=siz;  //override \0\0 with real
    size
    return (stuff +2);
}
```

Embodiment 2

The byte buffer storage data class is designed for supporting component programming, it provides the buffer area of storage byte. Refer to FIG. 2, it is an illustrative view showing the store structure of byte buffer storage data class:

Byte buffer storage data class is defined as a class in C++ language, it has a element variable bytc**m_ppbuf, i.e. the m_ppbuf in Fig. The byte buffer storage data class is defined as a pointer of byte*class in C language, the pointer is pointing to where the pointer _ezByteBuft_t is pointing to in FIG. 2.

For the byte buffer storage data class is pointing to where the pointer _ezByteBuf_t is pointing to in C language, refer to FIG. 2, it is compatible with the BSTR store structure of COM. A middle part of FIG. 2 is shown in FIG. 3; Refer to FIG. 2, the first 4 bytes is the 1^{st} part _ezByteBuf_t, the last 2 bytes is the 3^{rd} part, the middle part is 2^{nd} part capacity. The store value of 1st part is the 2^{nd} part length, what stored in 3^{rd} is end mark ‘\0’.

The other part is the extension to BSTR. The byte buffer storage data may be allocated in stack, or in pile.

If programming with C++, a byte buffer storage data variable buf of size length may be defined in stack with “byte buffer storage data <size>buf, or a EzByteBuf variable buf of _siz length may be defined in stack with the macro DECL_EZBYTEBUF(_buf, _siz).

If programming with C, only a EzByteBuf variable buf of _siz length may be defined with the macro DECL_EZBYTEBUF(_buf, _siz).

Embodiment 3

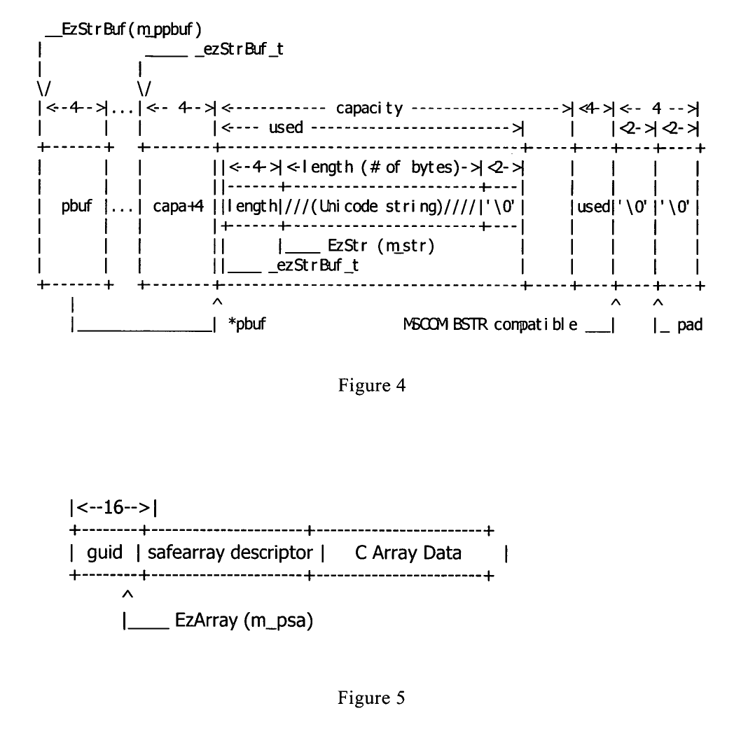

The character buffer storage data class is the combination of data class of said 2 embodiments. The main difference with byte buffer storage data is what stored in the character buffer storage data is a character string data object, but the byte buffer storage data class may store any data. Its storage structure is as FIG. 4.

Refer to FIG. 1-FIG. 3 and FIG. 4, the character buffer storage data class is a structure of storing a character string data structure in byte buffer storage data.

Same as said two data class, the character buffer storage data may be defined in stack or in pile.

Embodiment 4

Refer to FIG. 5, array data class define a array of multi-dimension, constant length, self-description data class, the store structure as FIG. 5. array data class is the extension to the Microsoft COM SAFEARRY. It was defined as a class in C++. The class has a element variable m_psa which is defined as a SAFEARRY pointer class. 16 bytes are be added before safearry descriptor in the embodiment for keeping the public mark (guid).

The array data class variable may be allocated to stack or pile.

The Ezdata class means data class of EzByteBuf, EzStrBuf, EzWCharBuf, EzArray. The detail applications are to be shown below.

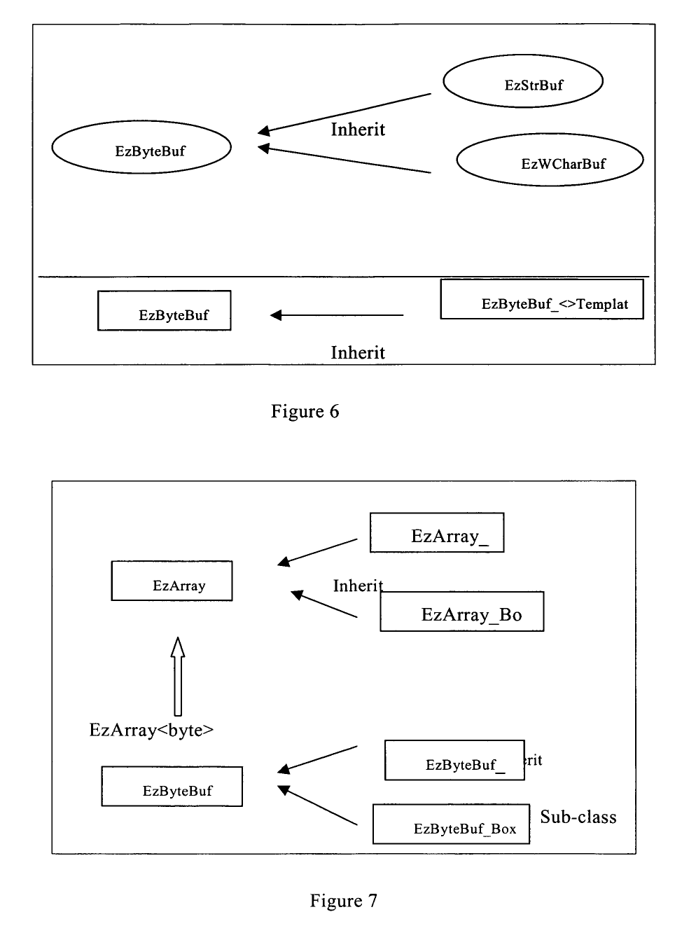

The realization relation is based on FIG. 6, EzCharBuf_<> template inherits EzCharBuf, EzStrBuf_<> inherits EzStrBuf, EzArray<T> template is realized alone, EzArray_<T>inherits the EzArray<T> template. The data class with underline may be transferred with force into the data class without underline in operation course.

The EzArray data class is compatible with the Microsoft SafeArray data class in order to make EzCOM component to operate in Microsoft platform, it may seen as a SafeArray* data class, the EzByteBuf, EzWCharBuf, EzStrBuf are compatible with BSTR, and are BSTR* data class. All the 4 data class is pointer.

The improved Ez data class keeps compatible with the data class supported by Microsoft, but in present: EzWCharBuf and EzByteBuf are realized by zArray<>, keeping compatible with SafeArray data class, EzStrBuf keeps compatible with BSTR. EzWCharBuf is a EzArray<wchar_t> data class in fact, EzByteBuf is a EzArray<byte> class. EzWCharBuf, EzByteBuf, EzArray is added with a Ezxxx_Box class sub-class(sub-template( ). Refer to FIG. 7, the relation between EzWCharBuf and EzArray is similar to the relation between EzByteBuf and EzArray, and has also two(sub-class) sub-templates.

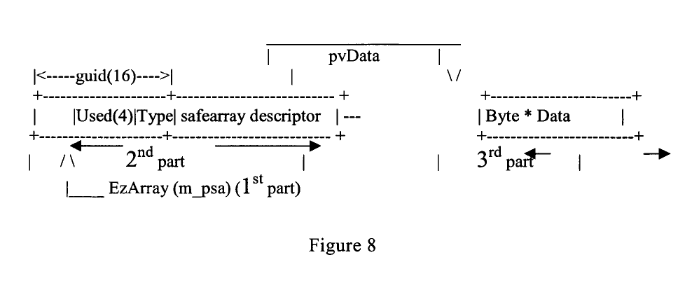

The EzArray is improved with more relative methods are added for supporting EzWCharBuf and EzByteBuf and for better utilizing the EzArray, to the improved EzArray data class store layout, refer to FIG. 8.

It should be noted that the EzArray is a pointer (1^{st} part m_psa) and is corresponding to the prior EzArray with difference of 2^{nd} and 3^{rd} parts no more connected. In this way it keeps compatible with SafeArray and doesn't need to copy in class changeover. For example, to a char* data class, the pvData of safearray descriptor may be pointed to where the data stored, rather than copy.

The store layout of EzArray_Box<> includes the 1^{st} part and 2^{nd} part in FIG. 8 as a sub-template; EzArray_ includes the 1^{st} part, 2^{nd} part and 3^{rd} part, in this way, the 2^{nd} part and 3^{rd} part of EzArray_ are connected together in fact. In store layout, EzArray is a pointer, EzArray object declaration is in fact the pointer declaration. The EzArray_Box is like a box pointed by pointer, all the data descriptions may be put in the box and the data storage position may be found through the box. The EzArray_is like a box with bag, the data descriptions are put in the box and the data itself is put in the bag. They are utilized respectively in the following condition:

Rule 1: if the data has been existed and the space has been allocated for data, the EzArray_Box is utilized for structuring the function. The data space is released by data itself.

Rule 2: if the data hasn't existed and the length couldn't be decided in compiling, the CreateInstance of EzArray is utilized, the space is allocated from pile and the data is structured. The data space is released through the dispose( ) method by user.

Rule 3, if the data hasn't existed but the length may be decided in compiling, the function is structured by EzArray_, the space is allocated from stack and the data is structured.

For better supported the EzArray data class, the following methods similar to prior EzByteBuf and EzStrBuf, and the structure function of EzArray_Box, EzArray_ have been added.

EzArray<T>::SetUsed (int siz)—set sizof(T)*siz bytes in the utilized data area.

EzArray<T>::Used( )—obtain the utilized data area spase length, with sizeof(T) as the unit.

EzArray<T>::IsEmpty( )—judge if the data area is empty, here means that if the pvData is NULL.

EzArray<T>::IsNull( )—judge if the EzArray is empty, here means that the m_psa is empty.

EzArray<T>::CreateInstance(int siz)—static function, a EzArray data structure is created in pile of which the class is T, data space length is sizeof(T)*siz, it should be noted that after utilization, it should be canceled by invoking Dispose.

EzArray<T>::Dispose( )—release the store occupied by EzArray data, it is used only for releasing the store of CreateInstance.

EzArray<T>::Clone( )—obtain a deep copy of EzArray object, i.e. copy the EzArray array in pile.

EzArray<T>::Realloc(int siz)—re-allocating the store space for the current EzArray array.

EzArray<T>::Copy (EzArray<T>src, int len)—copy the element of source EzArray array into the current EzArray array, and specify the array element amount to be copied.

EzArray<T>::CopyEx(const T*p, intn)—copy the p, of T* data class and n length (sizeof(T)as the unit) into the EzArray data space which has been structured.

EzArray<T>::Insert(const T*p,int offset, int n)—insert the data p, of n length into the position where is offset by “offset” in data area, with sizeof(T) as the unit, and the part which exceeds the data space would be truncated.

EzArray<T>::Append(constT*p,int n)—insert the data p, of n length into the end of utilized space in data area, and the part which exceeds the data space would be truncated.

EzArray<T>::T&operator[](int idx)—re-load [], making it to access through the form similar to array, such as EzArray<T>[idx].

EzArray<T>:: GetLength(USHORT cDims=1)—obtain the current EzArray array length.

EzArray_ is a template<class T, size_t SIZE> template, and inherits the EzArray. It supplies the following data function:

EzArray_( )—allocate the EzArray data class which has the data space length of sizeof(T)*SIZE in stack, and initialize the “used” to 0(recommend).

EzArray_(EzArray_<T,SIZE>&src)—allocate the EzArray data class which has the data space length of sizeof(T)*SIZE in stack, and partially initialize it with src data, note that it doesn't set the “used”

EzArray_Box is a template of “template<class T>” class, it inherits the EzArray, and provides the following structure function:

EzArray_Box(T*pArray, size_t SIZE, size_t used)—allocate in stack a safeArray, and make the pArray as its data area, set its length as SIZE and its application length as used(recommend).

EzArray_Box(T*pArray, size_t SIZE)—allocate in stack a safeArray, and make the pArray as its data area, set its length and application length both as SIZE (recommend).

EzArray_Box(EzArray_Box<T>&src)—allocate in stack a safeArray, and make the src as its data area, initialize its items according to the src.

The data utilization and the providing method of EzByteBuf, EzByteBuf,_ and EzWCharBuf, EzWCharBuf_ are same as before, but the sub class of EzByteBuf_Box and EzWCharBuf_Box are added, the two data class should be utilized in more times according to the above principle. Its structure functions are:

EzByteBuf_Box(void*buf, const UINT size, const UINT used)—allocate in stack a safeArray, and make the buf as its data area, set its length as SIZE and its application length as used(strongly recommend).

EzByteBuf_Box(void*buf, const UINT size)—allocate in stack a SafeArray, and make the buf as its data area, set its length and its application length both as size (strongly recommend).

The structure method provided by EzWCharBuf is similar.

The EzXXX_Box data structure is newly added, the differences between this data structure and EzXXX are:

The first, this data structure may utilize the existing data buffer as the 1^{st} item in above rule. The advantages are: save store, reduce copy between store, convenience to user and increase efficiency.

The second, this data structure utilizes the EzArray data structure, i.e. the Microsoft SAFEARRAY data structure, it makes the newly added EzXXX_Box data class is compatible to Windows.

These modifications don't affect the EzStrBuf application.

Moreover, the explanations about the constant IID_INTERFACE_INFO, ClassInfo(Class Information), CoInitialize, CoInitializeEx and general class field etc are as bellow: for every interface QueryInterface(IID_INTERFACE_INFO, (void**)ppv); the value in the return ppv is the IID of the interface. This is a extension to MS COM. All the interfaces inherit the IUnknown interface, so all the interfaces may be reflected to the Iunknown, but couldn't un-reflect after reflecting.

With this extension, you could do the un-reflecting.

While the present invention has been particularly shown and described with references to preferred embodiments thereof, it is clearly understood that the same is by way of illustration and example only and is not to be taken by way of limitation, it will be understood by those skilled in the art that various variations, alterations, and modifications in form and details may be made therein without departing from the spirit and scope of the invention as defined by the claims and it intended to be encompassed in the scope of the present invention.

We claim:

1. A processing method of self-description data object, characterized in that:
It includes at least: in data object utilization, allocate the relative store space to data object sample and assign the data object sample, in canceling the utilization of the data object sample, release the store space occupied by the data object.

2. A processing method of self-description data object according to claim 1, characterized in that:
The method includes further: judge the effectiveness of data object sample class, and return back the judge result.

3. A processing method of self-description data object according to claim 1, characterized in that:
The method includes further: changeover with force the utilized data object sample class.

4. A processing method of self-description data object according to claim 3, characterized in that:
When the data object sample is a character string object,
Said concrete operation of allocating the relative store space for data object includes at least: create the character string object sample for specified character string in memory, allocate the store space of specified effective length to the character string object sample;
Said concrete operation of allocating the relative store space for data object sample includes at least: re-create the character string object sample, and release the store space of original character string object sample; re-create the character string object sample according to the effective length, and release the store space of original character string object sample.

5. A processing method of self-description data object according to claim 3, characterized in that:
When the data object sample is a character string or character buffer storage object, the method includes further: read out the character string length or character number.

6. A processing method of self-description data object according to claim 3, characterized in that:
When the data object sample is a character string object, the method includes further: compare two character string objects.

7. A processing method of self-description data object according to claim 3, characterized in that:
When the data object sample is byte or character buffer storage object, said concrete operation of allocating the relative store space for data object sample is: if the byte or character buffer storage object sample doesn't existed, allocate non-initialized or initialized store space of specified quantity to the byte or character buffer storage object sample; otherwise it doesn't operate for store allocation.

8. A processing method of self-description data object according to claim 3, characterized in that:
When the data object sample is byte buffer storage object, the method includes further: read out the utilized byte number, set the utilized byte number, insert the specified new content in buffer storage space of byte buffer storage sample object, if it exceeds the volume of buffer storage space, the exceeded content would be truncated or lost.

9. A processing method of self-description data object according to claim 3, characterized in that:
When the data object sample is byte or character buffer storage object, the method includes further: read out the buffer area volume, assign new value to the existed byte buffer storage object, and add in new content behind the utilized buffer storage space, when it exceeds the buffer storage space, the exceeded part would be truncated.

10. A processing method of self-description data object according to claim 3, characterized in that:
When the data object sample is array object, said method includes at least: declare a array description, copy the array pointer; declare a array object and allocate the store for buffer area at same time, if the array object sample doesn't existed, allocate non-initialized or initialized store space of specified quantity to the array object sample, otherwise it doesn't operate for store allocation.

11. A processing method of self-description data object according to claim 3, characterized in that:
When the data object sample is array object, the method includes further: obtain the array length, access the array element, and create dynamically the array object, allocate the store for buffer area at same time, and return back the array description.

12. A processing method of self-description data object according to claim 3, characterized in that:
When the data object sample is array object, and delete the array object, the method includes further: delete the array buffer area, and release the occupied store space.

13. A processing method of self-description data object according to claim 4, characterized in that:
Said character string object has at least: 1^{st} area, 2^{nd} area and 3rd area; in which, the 1^{st} area stores the 2^{nd} area length; 2^{nd} area stores the uniform character coding standard character string; 3^{rd} area stores end mark.

14. A processing method of self-description data object according to claim 13, characterized in that:
Said character string object variable may be allocated to stack or pile.

15. A processing method of self-description data object according to claim 7, characterized in that:
Said byte buffer object has at least: 1^{st} part, 2^{nd} part and 3^{rd} part; in which, the 1^{st} part is for the 2^{nd} part length value; 2^{nd} part stores the byte data, 3^{rd} part stores end mark.

16. A processing method of self-description data object according to claim 15, characterized in that:
Said byte buffer object variable may be allocated to stack or pile.

17. A processing method of self-description data object according to claim 5, characterized in that:
Said character buffer storage object has at least: 1^{st} part, 2^{nd} part and 3^{rd} part; in which, the 1^{st} part is for the 2^{nd} part length value; 2^{nd} part stores the byte data, 3^{rd} part stores end mark.

18. A processing method of self-description data object according to claim 17, characterized in that:
Said byte data includes at least: 1^{st} area, 2^{nd} area and 3^{rd} area; in which, the 1^{st} area stores the 2^{nd} area length value; 2^{nd} area stores the uniform character coding standard character string; 3^{rd} area stores end mark.

19. A processing method of self-description data object according to claim 17, characterized in that:
Said character buffer storage object variable may be allocated to stack or pile.

20. A processing method of self-description data object according to claim 10, characterized in that:
Said array object has at least 3 parts: in which, the 1^{st} part stores the public mark (GUID), 2^{nd} part stores the safe array (SAFEARRAY), 3^{rd} part stores array data.

21. A processing method of self-description data object according to claim 20, characterized in that:
Said array object may be allocated to stack or pile.
